(19) United States
(12) Patent Application Publication
(10) Pub. No.: US 2003/0011308 A1
(43) Pub. Date: Jan. 16, 2003

(54) Method and device to install a germicidal fluorescent lamp, from one end, in fluid disinfection system

(76) Inventors: Keith M. Crawford, Canyon Country, CA (US); Roberto E. Arance, Valencia, CA (US); Richard Metzer, Pasadena, CA (US)

Correspondence Address: CISLO & THOMAS, LLP, 233 WILSHIRE BLVD, SUITE 900, SANTA MONICA, CA, 90401-1211, US

(21) Appl. No.: 10/195,652

(22) Filed: Jul. 11, 2002

Related U.S. Application Data
(60) Provisional application No. 60/305,508, filed on Jul. 13, 2001.

(51) Int. Cl. H01J 17/18

(52) U.S. Cl. 313/623

(57) ABSTRACT

A method and apparatus to install a germicidal fluorescent lamp that includes a single external electrical connection, and that protects the electric retainer wires or ballast from harmful exposure to the environment.

### CROSS-REFERENCES TO RELATED APPLICATIONS

This patent application is related to U.S. Provisional Patent Application Serial No. 60/305,508 filed Jul. 13, 2001 for GERMICIDAL FLUORESCENT LAMP, which application is incorporated herein by this reference thereto.

### BACKGROUND OF THE INVENTION

1. Field of the Invention

This invention relates to germicidal light fixtures, and more specifically to configurations for germicidal light fixtures that protect the electrical components of the device.

2. Description of the Related Art

Ultraviolet light is part of the light spectrum, which is classified into three wavelength ranges: UV-C, from 100 nanometers (nm) to 280 nm; UV-B, from 280 nm to 315 nm; and UV-A, from 315 nm to 400 nm. UV-C light is germicidal—i.e., it deactivates the DNA of bacteria, viruses and other pathogens and thus destroys their ability to multiply and cause disease. Specifically, UV-C light causes damage to the nucleic acid of microorganisms by forming covalent bonds between certain adjacent bases in the DNA. The formation of such bonds prevent the DNA from being unzipped for replication, and the organism is unable to reproduce. In fact, when the organism tries to replicate, it dies. Ultraviolet technology is a non-chemical approach to disinfection. In this method of disinfection, nothing is added which makes this process simple, inexpensive and requires very low maintenance. Ultraviolet purifiers utilize germicidal lamps and these units are designed and calculated to produce a certain dosage of ultraviolet (usually at least 16,000 microwatt seconds per square centimeter, but many units actually have a much higher dosage). The principle of design is based on a product of time and intensity—you must have a certain amount of both for a successful design. One of the applications for the germicidal capabilities is in the area of heating, ventilation and air conditioning (HVAC) systems. In the past, germicidal fluorescent lamps, used In a HVAC system have been used in two different configurations. Deficiencies exist with both:

In one configuration, a linear fluorescent bulb with filament connection or each end is installed in a fixture, or within the appliance. An electrical receptacle is required at each end of the lamp to electrically connect to the lamp filament. This is very much the same as in typical illumination type fluorescent fixtures. This configuration increases the complexity and cost of the lamp application. A fixture of means of containing that run to the far end of the lamp is required.

In another configuration, a single ended lamp is used. The lamp bulb has all four wires connected to pins on one end. One or two insulated electrical wires from the far end of the lamp run along the glass envelope to the connection end. Many lamp manufacturers (i.e. Philips, Light Sources, Inc., First Light) make this type of lamp for disinfection of water. It allows for the lamp to be cantilevered into the fluid with all electrical connections at one end only. The lamp is generally inserted in a quartz sleeve. For use in air, a sleeve is not required. A single ended lamp of this sort is ideal for use in air as all the mechanical support and electrical connections can be made on one end. However, this leaves a relatively unprotected wire in the HVAC equipment. This installation may not be recognized by regulatory agencies such as UL and the National Electric Code. The present invention is designed to eliminate these problems.

The present invention provides a means to protect lamp return wires also known as “ballast,” from damage. In addition, it allows the connections to meet regulatory agency standards such as UL and NEC, and thus allow cost-effective application of the lamp in an HVAC system where the lamp in connected and supported at a single end.

### SUMMARY OF THE INVENTION

The present invention comprises a fluorescent and/or germicidal UV lamp cartridge with all external electrical connectors at one end of the lamp. The lamp is most generally installed in a system of flowing air in order to disinfect the air stream. It could also be installed in a suitable fixture to facilitate disinfection of a surface or another fluid. A series of components (knob, inserts, cap, return tube and lamp bulb) when assembled, offer protection to lamp return wires when the lamp is installed in an environment such as an HVAC system.

### BRIEF DESCRIPTION OF THE DRAWINGS

FIG. 1 is an exploded view of an embodiment of the invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

A germicidal lamp installation device of the present invention includes a lamp, with a near end and a far end, where the near end and the far end each have contact pins and inserts. The near end also has a knob containing all external electrical connections, and the far end further includes an end cap for protecting the components of the device on the far end. The device also includes a conducting wire connected to said contact pins, and a wire return tube with a near end and a far end, where the near end of the wire return tube is connected to the insert by a clip washer, and the far end of said wire return tube is connected to said end cap by a second clip washer. The conducting wire is contained within the wire return tube to prevent exposure of the conducting wire to the external environment.

The wire return tube is between ⅛ inch and ⅜ inch in diameter, and is preferably ¼ inch in diameter, although any diameter within the range is acceptable. The wire return tube is preferably formed from a metallic material such as stainless steel, although steel, copper or aluminum are acceptable despite certain performance constraints.

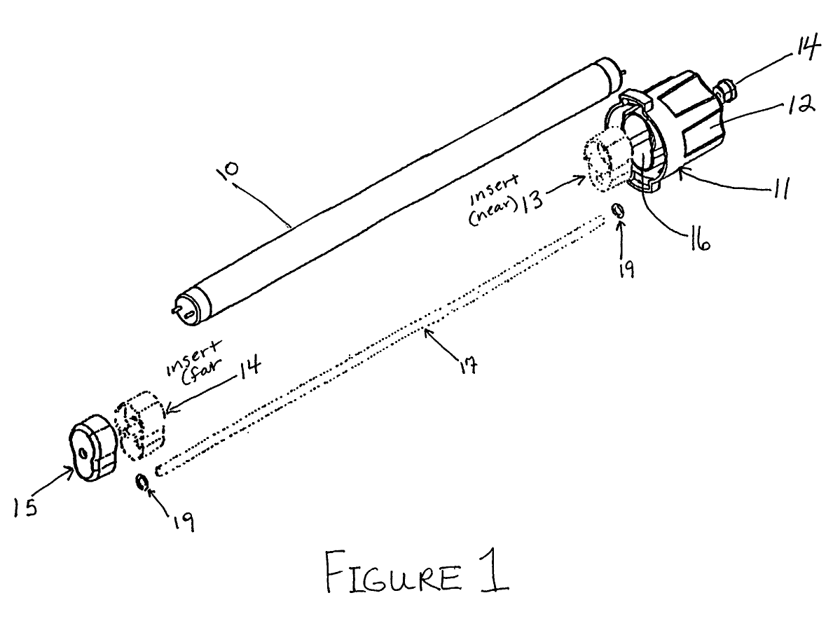

With the reference to FIG. 1, an embodiment of the invention incorporates a series of components comprising a knob, two inserts, and end-cap and a wire return tube. The two inserts are installed on either end of a linear UV-C germicidal lamp, trapping the lamp between them. These two components also trap a metal tube, which runs parallel to the lamp. Conducting wires are connected to the contacts at one end of the lamp (“far end”) and are inserted into the tube where they run through to the other end (“near end”); the end-cap covers the “far” component insert end to prevent exposure to the live contacts. Wires are connected to the near end of the lamp, and together with the wires from the far end, are routed through the knob as the near insert is attached to a matching receptacle in the knob.

Referring to FIG. 1 in greater detail, knobs 11 is preferably formed from a polymeric material, and include rectangular depressions 12 to assist in assembly and disassembly. Retaining nut 14 is located on one face of knob 11, and an elliptical opening 16 is located on a second face to receive rear insert 13, which is held in place partly by retaining nut 14. Lamp 10 is of elongated shape and conventional construction, with two-prong connectors on each end. The connectors are constructed to engage with rear insert 13 and far insert 14 in a known manner that creates an electrical and structural engagement. Far insert 14 is configured on one face for engagement with lamp 10 as described above, and on another face for engagement with end cap 15.

Wire retainer tube 17 is preferably formed from stainless steel which is sufficiently rigid and corrosion resistant to be suitable for use in the device. Copper, steel or aluminum may also be used but require special care in terms of construction, maintenance and operating environment. The size of return tube 17 depends on gauge of the wire that it will protect. For example, a 16 gauge wire will would require a ⅜ inch tube, whereas a 24 gauge wire would preferably us a ⅛ inch tube. The particular combination will depend on the design requirements necessary to accommodate a given environment.

Clip washers 19 strap the wire tube into engagement with inserts 13 and 14, and are preferably self crimping press fit washers. If the wire tube has threaded ends, a conventional nut and washer combination can be used.

In operation, the device is installed by connecting one end of the lamp to a source of power, and routing the conducting wires through the wire return tube to prevent exposure of the conducting wires to the external environment.

While the present invention has been described with regards to particular embodiments, it is recognized that additional variations of the present invention may be devised without departing from the inventive concept.

What is claimed is:

1. A germicidal lamp installation device, comprising:
A lamp, said lamp having a near end and a far end, said near end and said far end having contact pins;
a conducting wire connected to said contact pins, and
a wire return tube, whereby said conducting wire is contained within said wire return tube to prevent exposure of said conducting wire.

2. The germicidal lamp installation device of claim 1 wherein said wire return tube is between ⅛ inch and ⅜ inch in diameter.

3. The germicidal lamp installation device of claim 1 wherein said wire return tube is ⅛ inch in diameter.

4. The germicidal lamp installation device of claim 1 wherein said wire return tube is ¼ inch in diameter.

5. The germicidal lamp installation device of claim 1 wherein said wire return tube is ⅜ inch in diameter.

6. The germicidal lamp installation device of claim 4 wherein said wire return tube comprises a metallic material.

7. The germicidal lamp installation device of claim 6 wherein said wire return tube comprises stainless steel.

8. The germicidal lamp installation device of claim 6 wherein said wire return tube comprises aluminum.

9. The germicidal lamp installation device of claim 6 wherein said wire return tube comprises steel.

10. The germicidal lamp installation device of claim 6 wherein said wire return tube comprises copper.

11. The germicidal lamp installation device of claim 6 wherein said wire return tube is secured to said installation device with clip washers.

12. The germicidal lamp installation device of claim 6 wherein said wire return tube is threaded, and is secured to said installation device with threaded nuts.

13. A germicidal lamp installation device, comprising:
a lamp, said lamp having a near end and a far end, said near end and said far end each having contact pins and inserts, and said near end having a knob containing all external electrical connections, and said far end having an end cap;
a conducting wire connected to said contact pins, and a wire return tube with a near end and a far end, whereby said near end of said wire return tube is connected to said insert by a clip washer, and said far end of said wire return tube is connected to said end cap by a second clip washer, and said conducting wire is contained within said wire return tube to prevent exposure of said conducting wire.

14. The germicidal lamp installation device of claim 13 wherein said wire return tube is between ⅛ inch and ⅜ inch in diameter.

15. The germicidal lamp installation device of claim 14 wherein said wire return tube comprises a metallic material.

16. The germicidal lamp installation device of claim 15 wherein said wire return tube comprises stainless steel.

17. The germicidal lamp installation device of claim 16 wherein said wire return tube is ¼ inch in diameter.

18. A method of installing a germicidal lamp comprising:
providing one end of a fluorescent lamp with means to connect to a source of power, and
providing a wire return tube whereby one or more conducting wires are routed through said wire return tube to prevent exposure of said conducting wires.
